(19) United States
(12) Patent Application Publication
(10) Pub. No.: US 2019/0217866 A1
(43) Pub. Date: Jul. 18, 2019

(54) METHOD AND APPARATUS FOR DETERMINING FUEL ECONOMY

(71) Applicant: GM GLOBAL TECHNOLOGY OPERATIONS LLC, Detroit, MI (US)

(72) Inventor: Aaron P. Creguer, FENTON, MI (US)

(21) Appl. No.: 15/874,462

(22) Filed: Jan. 18, 2018

(51) Int. Cl. B60W 40/12; B60W 50/14

(52) U.S. Cl. CPC B60W 40/12; B60W 50/14; B60W 2400/00; B60W 2530/10; B60W 2050/146; B60W 2530/16; B60W 2530/18; B60W 2560/02; B60W 2530/14

(57) ABSTRACT

A method and apparatus for determining fuel economy are provided. The method includes determining whether a trailer is connected to a vehicle and trailer profile information of the trailer connected to the vehicle, calculating a first fuel economy according to a first calculation for determining fuel economy if the determining determines that the trailer is not connected to the vehicle, calculating a second fuel economy according to a second calculation for determining fuel economy if the determining determines that the trailer is connected to the vehicle. The calculating the fuel economy according to the second calculation is performed based on the trailer profile including at least one from among trailer identification information, trailer weight information, trailer aerodynamic information, and trailer fuel economy offset information.

### INTRODUCTION

Apparatuses and methods consistent with exemplary embodiments relate to determining a fuel economy. More particularly, apparatuses and methods consistent with exemplary embodiments relate to determining a fuel economy of a vehicle under different driving conditions.

### SUMMARY

One or more exemplary embodiments provide a method and an apparatus that determines whether a trailer is connected to a vehicle and that calculate a fuel economy differently based on whether the trailer is connected to the vehicle. More particularly, one or more exemplary embodiments provide a method and an apparatus that retrieve a trailer profile when a trailer is connected to a vehicle, and calculate a fuel economy of a vehicle based on the specifications of the trailer that is connected to the vehicle.

According an aspect of an exemplary embodiment, a method for determining a fuel economy is provided. The method includes determining whether a trailer is connected to a vehicle and trailer profile information of the trailer connected to the vehicle, calculating a first fuel economy according to a first calculation for determining fuel economy if the determining determines that the trailer is not connected to the vehicle, calculating a second fuel economy according to a second calculation for determining fuel economy if the determining determines that the trailer is connected to the vehicle, The calculating the fuel economy according to the second calculation may be performed based on the trailer profile information including at least one from among trailer identification information, trailer weight information, trailer aerodynamic information, trailer fuel economy offset information, and historical trailer fuel economy information.

The method may further include receiving an input indicating whether the trailer is connected to a vehicle via at least one from among a user input, a trailer detection sensor, and a wireless communication device.

The method may further include receiving the trailer profile information via at least one from among a user input, a trailer detection sensor, and a communication device.

The method may further include displaying the second fuel economy if the determining determines that the trailer is connected to the vehicle; and displaying the first fuel economy if the determining determines that the trailer is disconnected from the vehicle.

The calculating the fuel economy may include determining a change in distance traveled while the trailer is connected to the vehicle by reading a memory storing odometer information of the vehicle, measuring fuel level change after the distance is traveled by reading a memory storing fuel level information, and calculating the fuel economy based on the change in distance and the fuel level change.

The trailer weight information may be a gross weight of the trailer. The trailer aerodynamic information may be a drag coefficient. The trailer fuel economy offset information may be a number that is used to offset the first fuel economy to calculate the second fuel economy. The trailer identification information may be an identification number used to lookup specifications of the trailer.

According an aspect of an exemplary embodiment, an apparatus for determining a fuel economy is provided. The apparatus includes at least one memory comprising computer executable instructions; and at least one processor configured to read and execute the computer executable instructions. The computer executable instructions may cause the at least one processor to determine whether a trailer is connected to a vehicle and trailer profile information of the trailer connected to the vehicle, calculate a first fuel economy according to a first calculation for determining fuel economy if the at least one processor determines that the trailer is not connected to the vehicle, calculate a second fuel economy according to a second calculation for determining fuel economy if the at least one processor determines that the trailer is connected to the vehicle. The at least one processor may be configured to calculate the fuel economy according to the second calculation based on the trailer profile including at least one from among trailer identification information, trailer weight information, trailer aerodynamic information, trailer fuel economy offset information, and historical trailer fuel economy information.

The computer executable instructions may cause the at least one processor to receive an input indicating whether the trailer is connected to a vehicle via at least one from among a user input, a trailer detection sensor, and a communication device.

The computer executable instructions may cause the at least one processor to receive the trailer profile information via at least one from among a user input, a trailer connector interface, and a wireless communication device.

The computer executable instructions may cause the at least one processor to display the second fuel economy if the at least one processor determines that the trailer is connected to the vehicle and display the first fuel economy if the at least one processor determines that the trailer is disconnected from the vehicle.

The computer executable instructions may cause the at least one processor to calculate the fuel economy further by determining a change in distance traveled while the trailer is connected to the vehicle by reading a memory storing odometer information of the vehicle, measuring fuel level change after the distance is traveled from a memory storing fuel level information, and calculating the fuel economy based on the change in distance and the fuel level change.

The trailer weight information may comprise a gross weight of the trailer. The trailer aerodynamic information may include a drag coefficient. The trailer fuel economy offset information may include a number that is used to offset the first fuel economy to calculate the second fuel economy. The trailer identification information may include an identification number used to lookup specifications of the trailer.

According an aspect of an exemplary embodiment, an apparatus for determining a fuel economy is provided. The apparatus includes at least one memory comprising computer executable instructions; and at least one processor configured to read and execute the computer executable instructions. The computer executable instructions may cause the at least one processor to receive at least one from among an input indicating whether a trailer is connected to a vehicle and trailer profile information of the trailer connected to the vehicle, calculate a fuel economy according to a first calculation for determining fuel economy if the input indicates that the trailer is disconnected from the vehicle, calculate a fuel economy according to a second calculation for determining fuel economy if the input indicates that the trailer is connected to the vehicle. The at least one processor may be configured to calculate the fuel economy according to the second calculation based on the trailer profile including at least one from among trailer identification information, trailer weight information, trailer aerodynamic information, and trailer fuel economy offset information.

Other objects, advantages and novel features of the exemplary embodiments will become more apparent from the following detailed description of exemplary embodiments and the accompanying drawings.

### BRIEF DESCRIPTION OF THE DRAWINGS

FIG. 1 shows a block diagram of an apparatus that determines fuel economy according to an exemplary embodiment; and

FIG. 2 shows a flowchart for a method that determines fuel economy according to an exemplary embodiment.

### DETAILED DESCRIPTION OF EXEMPLARY EMBODIMENTS

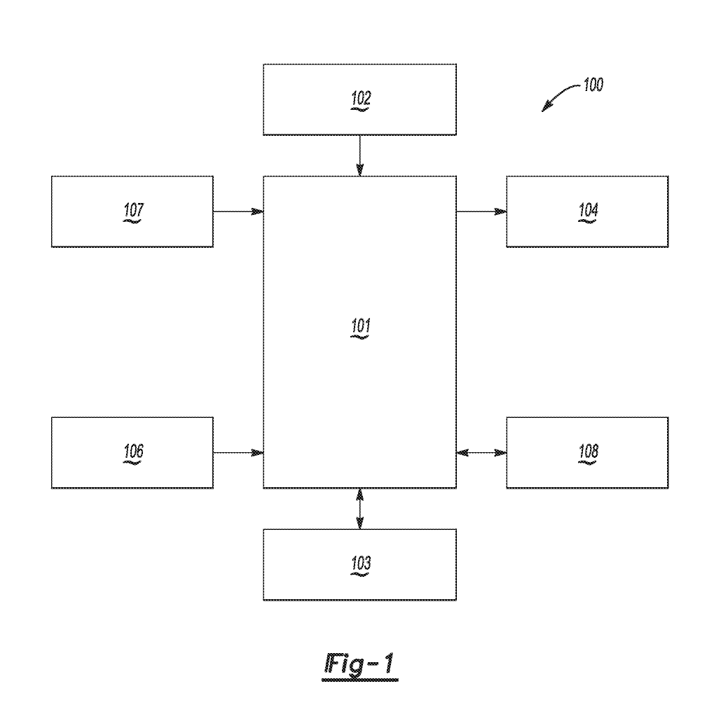

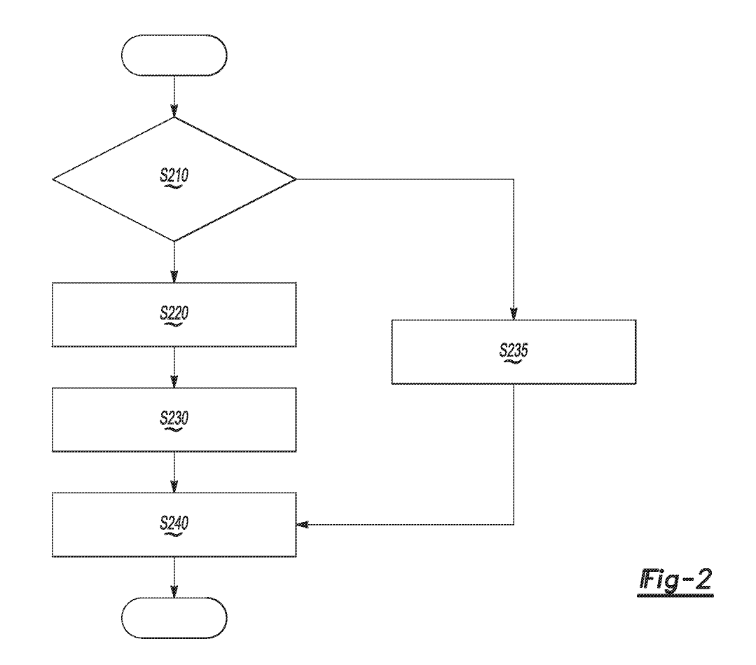

An apparatus and method for determining a fuel economy of a vehicle according to the type of trailer that is connected to a vehicle will now be described in detail with reference to FIGS. 1 and 2 of the accompanying drawings in which like reference numerals refer to like elements throughout.

The following disclosure will enable one skilled in the art to practice the inventive concept. However, the exemplary embodiments disclosed herein are merely exemplary and do not limit the inventive concept to exemplary embodiments described herein. Moreover, descriptions of features or aspects of each exemplary embodiment should typically be considered as available for aspects of other exemplary embodiments.

It is also understood that where it is stated herein that a first element is “connected to,” “attached to,” “formed on,” or “disposed on” a second element, the first element may be connected directly to, formed directly on or disposed directly on the second element or there may be intervening elements between the first element and the second element, unless it is stated that a first element is “directly” connected to, attached to, formed on, or disposed on the second element. In addition, if a first element is configured to “send” or “receive” information from a second element, the first element may send or receive the information directly to or from the second element, send or receive the information via a bus, send or receive the information via a network, or send or receive the information via intermediate elements, unless the first element is indicated to send or receive information “directly” to or from the second element.

Throughout the disclosure, one or more of the elements disclosed may be combined into a single device or into one or more devices. In addition, individual elements may be provided on separate devices.

Vehicles and other machines now include various sensors and devices that provide additional information to assist operators or drivers with the operation of the vehicle and connected elements. One example of information provided by the sensors or devices may be information about a trailer connected to the vehicle. This information is useful to an operator because it allows an operator to better operate the vehicle by understanding how the attached object or trailer affects vehicle dynamics, vehicle performance, and other vehicle operation. In one example, an attached trailer may affect fuel economy. However, the effect on fuel economy may not immediately be realized by an operator of a vehicle because a vehicle's fuel economy display only takes into account the vehicle itself when determining and displaying fuel economy.

To address the above issue, trailer profile information may be used if a trailer is connected to a vehicle to determine a more accurate fuel economy of the vehicle and provide a fuel range for the vehicle. The trailer profile information may be retrieved or determined when a trailer is detected as being connected to a vehicle, either through a trailer sensor, user input, or communication device. The trailer profile information may then be used to perform a second calculation for fuel economy that takes into consideration the trailer profile information. The result of the second calculation may then be displayed to an operator of a vehicle.

FIG. 1 shows a block diagram of an apparatus that determines fuel economy 100 according to an exemplary embodiment. As shown in FIG. 1, the apparatus that determines fuel economy 100, according to an exemplary embodiment, includes a controller 101, a power supply 102, a storage 103, an output 104, a user input 106, a trailer detection sensor 107 (i.e., a trailer detector), and a communication device 108. However, the apparatus that determines fuel economy 100 is not limited to the aforementioned configuration and may be configured to include additional elements and/or omit one or more of the aforementioned elements. The apparatus that determines fuel economy 100 may be implemented as part of a vehicle, as a standalone component, as a hybrid between an on vehicle and off vehicle device, or in another computing device.

The controller 101 controls the overall operation and function of the apparatus that determines fuel economy 100. The controller 101 may control one or more of a storage 103, an output 104, a user input 106, a trailer detection sensor 107, and a communication device 108 of the apparatus that determines fuel economy 100. The controller 101 may include one or more from among a processor, a microprocessor, a central processing unit (CPU), a graphics processor, Application Specific Integrated Circuits (ASICs), Field-Programmable Gate Arrays (FPGAs), state machines, circuitry, and a combination of hardware, software and firmware components.

The controller 101 is configured to send and/or receive information from one or more of the storage 103, the output 104, the user input 106, the trailer detection sensor 107, and the communication device 108 of the apparatus that determines fuel economy 100. The controller 101 may send and/or receive information including commands and controls to/from the appropriate vehicle component, module, ECU, etc. The information may be sent and received via a bus or network, or may be directly read or written to/from one or more of the storage 103, the output 104, the user input 106, the trailer detection sensor 107, and the communication device 108 of the apparatus that determines fuel economy 100. Examples of suitable network connections include a controller area network (CAN), a media oriented system transfer (MOST), a local interconnection network (LIN), a local area network (LAN), wireless networks such as Bluetooth and 802.11, and other appropriate connections such as Ethernet.

The power supply 102 provides power to one or more of the controller 101, the storage 103, the output 104, the user input 106, the trailer detection sensor 107, and the communication device 108, of the apparatus that determines fuel economy 100. The power supply 102 may include one or more from among a battery, an outlet, a capacitor, a solar energy cell, a generator, a wind energy device, an alternator, etc.

The storage 103 is configured for storing information and retrieving information used by the apparatus that determines fuel economy 100. The storage 103 may be controlled by the controller 101 to store and retrieve information received from the trailer detection sensor 107. The information may include trailer profile information of a trailer connected to a vehicle. The trailer profile information may include one or more from among trailer identification information, trailer weight information, trailer aerodynamic information, trailer fuel economy offset information, and historical trailer fuel economy information. The storage 103 may also include the computer instructions configured to be executed by a processor to perform the functions of the apparatus that determines fuel economy 100.

The trailer weight information may include a weight value corresponding to a trailer such as the gross weight of the trailer. The trailer aerodynamic information include a drag coefficient. The trailer fuel economy offset information may include a number that is used to offset the first fuel economy of the vehicle to calculate the second fuel economy of the vehicle with the trailer attached. The trailer identification information comprises an identification number used to lookup specifications of the trailer, e.g., weight, drag coefficient, etc.

The historical trailer fuel economy information may be the historical fuel economy of the vehicle measured when the trailer was previously connected to the vehicle. The historical trailer fuel economy information may be determined by determining a change in distance traveled while the trailer is connected to the vehicle by reading a memory storing odometer information of the vehicle, measuring fuel level change after the distance is traveled from a memory storing fuel level information, and calculating the fuel economy based on the change in distance and the fuel level change. The calculated fuel economy may then be calculated and stored at different points in time to maintain the historical trailer fuel economy information. In one example, the historical trailer fuel economy information may be a running average or weighted average value.

The storage 103 may include one or more from among floppy diskettes, optical disks, CD-ROMs (Compact Disc-Read Only Memories), magneto-optical disks, ROMs (Read Only Memories), RAMs (Random Access Memories), EPROMs (Erasable Programmable Read Only Memories), EEPROMs (Electrically Erasable Programmable Read Only Memories), magnetic or optical cards, flash memory, cache memory, and other type of media/machine-readable medium suitable for storing machine-executable instructions.

The output 104 outputs information in one or more forms including: visual, audible and/or haptic form. The output 104 may be controlled by the controller 101 to provide outputs to the user of the apparatus that determines fuel economy 100. In addition, the output 104 may include one or more from among a speaker, an audio device, a display, a centrally-located display, a head up display, a windshield display, a haptic feedback device, a vibration device, a tactile feedback device, a tap-feedback device, a holographic display, an instrument light, an indicator light, etc.

The output 104 may also output notification including one or more from among an audible notification, a light notification, and a display notification. For example, the output 104 may display a notification or graphic indicating that the trailer is connected. Moreover, the output 104 may display the second fuel economy if the controller 101 determines that the trailer is connected to the vehicle and display the first fuel economy if the controller 101 determines that the trailer is disconnected from the vehicle.

The user input 106 is configured to provide information and commands to the apparatus that determines fuel economy 100. The user input 106 may be used to provide user inputs, etc., to the controller 101. The user input 106 may include one or more from among a touchscreen, a keyboard, a soft keypad, a button, a motion detector, a voice input detector, a microphone, a camera, a trackpad, a mouse, a touchpad, etc. The user input 106 may be configured to receive a user input to acknowledge or dismiss the notification output by the output 104.

The user input 106 may also be configured to receive a user input indicating whether the trailer is connected to a vehicle via at least one from among a user input, a trailer sensor, and a communication device. In addition, the user input 106 may be configured to receive trailer profile information from an occupant of a vehicle.

The trailer detection sensor 107 may include one or more from among a plurality of sensors including an imaging sensor, a camera, a laser sensor, a switch, an electrical connection detector, a trailer connector interface, an ultrasonic sensor, an infrared camera, a LIDAR, a radar sensor, an ultra-short range radar sensor, an ultra-wideband radar sensor, and a microwave sensor. The trailer detection sensor 107 may detect the presence of trailer.

The communication device 108 may be used by the apparatus that determines fuel economy 100 to communicate with various types of external apparatuses according to various communication methods. The communication device 108 may be used to send/receive information including trailer profile information via a trailer connector interface or a wireless communication device. The communication device may also be configured to receive information of an accelerometer, a speedometer, a weight sensor, an ultrasonic sensor, an odometer, a radar sensor, and/or a wheel speed sensor.

The communication device 108 may include various communication modules such as one or more from among a telematics unit, a broadcast receiving module, a near field communication (NFC) module, a GPS receiver, a wired communication module, or a wireless communication module. The broadcast receiving module may include a terrestrial broadcast receiving module including an antenna to receive a terrestrial broadcast signal, a demodulator, and an equalizer, etc. The NFC module is a module that communicates with an external apparatus located at a nearby distance according to an NFC method. The GPS receiver is a module that receives a GPS signal from a GPS satellite and detects a current location. The wired communication module may be a module that receives information over a wired network such as a local area network, a controller area network (CAN), or an external network. The wireless communication module is a module that is connected to an external network by using a wireless communication protocol such as IEEE 802.11 protocols, WiMAX, Wi-Fi or IEEE communication protocol and communicates with the external network. The wireless communication module may further include a mobile communication module that accesses a mobile communication network and performs communication according to various mobile communication standards such as 3^{rd} generation (3G), 3^{rd} generation partnership project (3GPP), long-term evolution (LTE), Bluetooth, EVDO, CDMA, GPRS, EDGE or ZigBee.

According to an exemplary embodiment, the controller 101 of the apparatus that determines fuel economy 100 may be configured to determine whether a trailer is connected to a vehicle and trailer profile information of the trailer connected to the vehicle, calculate a first fuel economy according to a first calculation for determining fuel economy if the at least one processor determines that the trailer is not connected to the vehicle, calculate a second fuel economy according to a second calculation for determining fuel economy if the at least one processor determines that the trailer is connected to the vehicle. The controller 101 may be configured to calculate the fuel economy according to the second calculation based on the trailer profile including at least one from among trailer identification information, trailer weight information, trailer aerodynamic information, and trailer fuel economy offset information.

The controller 101 of the apparatus that determines fuel economy 100 may be configured to receive at least one from among an input indicating whether a trailer is connected to a vehicle and trailer profile information of the trailer connected to the vehicle, calculate a fuel economy according to a first calculation for determining fuel economy if the input indicates that the trailer is disconnected from the vehicle, calculate a fuel economy according to a second calculation for determining fuel economy if the input indicates that the trailer is connected to the vehicle. The controller 101 may be configured to calculate the fuel economy according to the second calculation based on the trailer profile including at least one from among trailer identification information, trailer weight information, trailer aerodynamic information, and trailer fuel economy offset information.

The controller 101 may also be configured to receive an input indicating whether the trailer is connected to a vehicle via at least one from among a user input 106, a trailer detection sensor 107, and a communication device 108. The controller may also be configured to receive the trailer profile information via at least one from among a user input 106, a trailer connector interface of a trailer detection sensor 107, and a wireless communication device 108.

The controller 101 may also be configured to control output 104 to display the second fuel economy if the controller 101 determines that the trailer is connected to the vehicle and display the first fuel economy if the controller 101 determines that the trailer is disconnected from the vehicle.

FIG. 2 shows a flowchart for a method for determining fuel economy according to an exemplary embodiment. The method of FIG. 2 may be performed by the apparatus that determines fuel economy 100 or may be encoded into a computer readable medium as instructions that are executable by a computer to perform the method.

Referring to FIG. 2, operation S210 determines whether a trailer is connected to a vehicle. If it is determined that a trailer is not connected to or disconnected form the vehicle (operation S210—No), the fuel economy of the vehicle is calculated according to a first calculation based on a trailer-less equation or formula in operation S235. Then, the calculated average fuel economy is displayed in operation S240.

If the trailer is connected to the vehicle in operation S210—Yes, the type and/or specifications of the connected trailer is determined based on trailer profile information in operation S220. Then, in operation S230, the fuel economy is calculated based on a second calculation or trailer based formula that uses trailer profile information to make a determination of fuel economy. The calculated fuel economy according to the second calculation is displayed in operation 240.

The fuel economy may be calculated by determining an average fuel economy when the trailer is connected to a vehicle and associating the determined average fuel economy with trailer identification information. For example, if it is determined that a trailer with identification number 1 is connected to the vehicle, the average fuel economy can be determined by measuring fuel consumption and dividing the distance traveled by the measured fuel consumption. The average fuel economy calculation may be performed periodically at predetermined periods of time or at predetermined intervals of distance traveled. The average fuel economy can then be used to determine fuel range by multiplying the amount fuel left in a vehicle by the average fuel economy.

The average fuel economy or the fuel range for a trailer with the identification number 1 can then be stored in a lookup table and be continuously updated or updated on demand. The lookup table may be used to retrieve the average fuel economy or the fuel range of a trailer based on the identification number and display the average fuel economy or the fuel range on a display in vehicle.

The processes, methods, or algorithms disclosed herein can be deliverable to/implemented by a processing device, controller, or computer, which can include any existing programmable electronic control device or dedicated electronic control device. Similarly, the processes, methods, or algorithms can be stored as data and instructions executable by a controller or computer in many forms including, but not limited to, information permanently stored on non-writable storage media such as ROM devices and information alterably stored on writeable storage media such as floppy disks, magnetic tapes, CDs, RAM devices, and other magnetic and optical media. The processes, methods, or algorithms can also be implemented in a software executable object. Alternatively, the processes, methods, or algorithms can be embodied in whole or in part using suitable hardware components, such as Application Specific Integrated Circuits (ASICs), Field-Programmable Gate Arrays (FPGAs), state machines, controllers or other hardware components or devices, or a combination of hardware, software and firmware components.

One or more exemplary embodiments have been described above with reference to the drawings. The exemplary embodiments described above should be considered in a descriptive sense only and not for purposes of limitation. Moreover, the exemplary embodiments may be modified without departing from the spirit and scope of the inventive concept, which is defined by the following claims.

What is claimed is:

1. A method for determining fuel economy, the method comprising:
determining whether a trailer is connected to a vehicle and trailer profile information of the trailer connected to the vehicle;
calculating a first fuel economy according to a first calculation for determining fuel economy if the determining determines that the trailer is not connected to the vehicle; and
calculating a second fuel economy according to a second calculation for determining fuel economy if the determining determines that the trailer is connected to the vehicle,
wherein the calculating the fuel economy according to the second calculation is performed based on the trailer profile information including at least one from among trailer identification information, trailer weight information, trailer aerodynamic information, trailer fuel economy offset information, and historical trailer fuel economy information.

2. The method of claim 1, further comprising receiving an input indicating whether the trailer is connected to the vehicle via at least one from among a user input, a trailer detection sensor, and a wireless communication device.

3. The method of claim 2, further comprising receiving the trailer profile information via at least one from among the user input, a trailer detection sensor, and a communication device.

4. The method of claim 3, further comprising:
displaying the second fuel economy if the determining determines that the trailer is connected to the vehicle; and
displaying the first fuel economy if the determining determines that the trailer is disconnected from the vehicle.

5. The method of claim 1, wherein the calculating the fuel economy further comprises determining a change in distance traveled while the trailer is connected to the vehicle by reading a memory storing odometer information of the vehicle, measuring fuel level change after the distance is traveled by reading a memory storing fuel level information, and calculating the fuel economy based on the change in distance and the fuel level change.

6. The method of claim 1, wherein the trailer weight information comprises a gross weight of the trailer.

7. The method of claim 1, wherein the trailer aerodynamic information comprises a drag coefficient.

8. The method of claim 1, wherein the trailer fuel economy offset information comprises a number that is used to offset the first fuel economy to calculate the second fuel economy.

9. The method of claim 1, wherein the trailer identification information comprises an identification number used to lookup specifications of the trailer.

10. A non-transitory computer readable medium comprising instructions executable by a computer to perform the method of claim 1.

11. An apparatus that determines fuel economy, the apparatus comprising:
at least one memory comprising computer executable instructions; and
at least one processor configured to read and execute the computer executable instructions, the computer executable instructions causing the at least one processor to:
determine whether a trailer is connected to a vehicle and trailer profile information of the trailer connected to the vehicle;
calculate a first fuel economy according to a first calculation for determining fuel economy if the at least one processor determines that the trailer is not connected to the vehicle; and
calculate a second fuel economy according to a second calculation for determining fuel economy if the at least one processor determines that the trailer is connected to the vehicle,
wherein the at least one processor configured to calculate the fuel economy according to the second calculation based on the trailer profile including at least one from among trailer identification information, trailer weight information, trailer aerodynamic information, trailer fuel economy offset information, and historical trailer fuel economy information.

12. The apparatus of claim 11, wherein the computer executable instructions cause the at least one processor to receive an input indicating whether the trailer is connected to the vehicle via at least one from among a user input, a trailer detection sensor, and a communication device.

13. The apparatus of claim 12, wherein the computer executable instructions cause the at least one processor to receive the trailer profile information via at least one from among the user input, a trailer connector interface, and a wireless communication device.

14. The apparatus of claim 13, wherein the computer executable instructions cause the at least one processor to display the second fuel economy if the at least one processor determines that the trailer is connected to the vehicle and display the first fuel economy if the at least one processor determines that the trailer is disconnected from the vehicle.

15. The apparatus of claim 11, wherein the computer executable instructions cause the at least one processor to calculate the fuel economy further by determining a change in distance traveled while the trailer is connected to the vehicle by reading a memory storing odometer information of the vehicle, measuring fuel level change after the distance is traveled by reading a memory storing fuel level information, and calculating the fuel economy based on the change in distance and the fuel level change.

16. The apparatus of claim 11, wherein the trailer weight information comprises a gross weight of the trailer.

17. The apparatus of claim 11, wherein the trailer aerodynamic information comprises a drag coefficient.

18. The apparatus of claim 11, wherein the trailer fuel economy offset information comprises a number that is used to offset the first fuel economy to calculate the second fuel economy.

19. The apparatus of claim 11, wherein the trailer identification information comprises an identification number used to lookup specifications of the trailer.

20. An apparatus for determining fuel economy, the apparatus comprising:
at least one memory comprising computer executable instructions; and
at least one processor configured to read and execute the computer executable instructions, the computer executable instructions causing the at least one processor to:
receive at least one from among an input indicating whether a trailer is connected to a vehicle and trailer profile information of the trailer connected to the vehicle;
calculate a first fuel economy according to a first calculation for determining fuel economy if the input indicates that the trailer is disconnected from the vehicle; and
calculate a second fuel economy according to a second calculation for determining fuel economy if the input indicates that the trailer is connected to the vehicle,
wherein the at least one processor is configured to calculate the fuel economy according to the second calculation based on the trailer profile including at least one from among trailer identification information, trailer weight information, trailer aerodynamic information, and trailer fuel economy offset information.
